(19) United States
(12) Patent Application Publication
(10) Pub. No.: US 2014/0024763 A1
(43) Pub. Date: Jan. 23, 2014

(54) PROCESS FOR PRODUCING PIGMENT-ENCAPSULATING RESIN DISPERSION AND INK JET INK

(71) Applicant: Canon Kabushiki Kaisha, Tokyo (JP)

(72) Inventors: Masanori Jinnou, Chita-gun (JP); Takahiro Mori, Inagi-shi (JP); Satoru Kobayashi, Yokohama-shi (JP); Shinichi Sakurada, Tokyo (JP); Yutaka Kurabayashi, Higashimurayama-shi (JP)

(21) Appl. No.: 13/928,791

(22) Filed: Jun. 27, 2013

(30) Foreign Application Priority Data
Jul. 23, 2012 (JP) 2012-162988

(51) Int. Cl. C09D 11/00

(52) U.S. Cl. CPC C09D 11/30
USPC 524/460; 524/855

(57) ABSTRACT

The invention provides a process for producing a pigment-encapsulating polymer dispersion, comprising the steps of dispersing a liquid containing a monomer, a hydrophobe and a polymerization initiator into a water medium with a dispersant to obtain a monomer emulsion, and mixing the monomer emulsion with a pigment dispersion containing a self-dispersible pigment to which a hydrophilic group is bonded directly or through another atomic group and which is dispersed by the hydrophilic group, subjecting the resultant mixture to a shearing treatment and then polymerizing the monomer.

### BACKGROUND OF THE INVENTION

1. Field of the Invention

The present invention relates to a process for producing a pigment-encapsulating polymer dispersion and an ink jet ink containing a pigment-encapsulating polymer dispersion produced by this production process.

2. Description of the Related Art

As a process for producing a pigment-encapsulating polymer dispersion, there has been proposed “ad-miniemulsion polymerization process” (Non Patent Literature 1: K. Landfester, “Macromolecular”, Vol. 292, pp. 1111-1125, 2007). In recent years, this ad-miniemulsion polymerization process has been expected to be applied to a field of various coloring materials. Non Patent Literature 1 suggests that this process can be applied to a field of ink jet. In such a pigment-encapsulating polymer dispersion, a polymer encapsulating a pigment functions as a binder when the dispersion is used in an ink jet ink, so that it is expected to improve the rub-off resistance of an image to be recorded.

In the ad-miniemulsion polymerization process to date, a pigment dispersion with a pigment dispersed in water with a dispersant and a monomer emulsion with a monomer dispersed in water with a dispersant likewise are used. These pigment dispersion and monomer emulsion are mixed and stirred and further subjected to a shearing treatment (for example, ultrasonic treatment or homogenizer treatment) in which strong shearing force is applied, whereby fission and fusion are repeatedly caused between the pigment and the monomer, and finally a thin monomer layer is stably adsorbed, on the surface of the pigment. Thereafter, polymerization is conducted under general polymerization conditions, whereby a pigment-encapsulating polymer dispersion can be obtained.

A process for producing a pigment-encapsulating polymer dispersion by using a coloring material such as carbon black or a color pigment to which no surface treatment by the ad-miniemulsion polymerization process is subjected has heretofore been known. In addition, an example where a mixed liquid of a monomer, a polymerization initiator and a hydrophobe is mixed into a dispersion with a pigment dispersed in water with a dispersant, the resultant mixture is ultrasonically dispersed, and polymerization is then conducted, thereby encapsulating the pigment in the polymer is known (Patent Literature 1; Japanese Patent Application Laid-Open No. 2005-097518).

The present inventors have investigated the above-described techniques in detail. As a result, it has been found that when the pigment-encapsulating polymer dispersion in which the dispersant remains as an isolated component is used in an ink jet ink, inconvenience may be caused to ejection characteristics in some cases. Specifically, such a phenomenon that the dispersant isolated in the system sticks to surroundings of an ejection orifice to change a flying direction of an ink droplet ejected, and so an intended image is not recorded may occur in some cases (hereinafter also referred to as “dot misalignment phenomenon”). The dispersant isolated in the system can be removed or reduced by purification such as ultrafiltration. However, the dispersibility of the pigment-encapsulating polymer is lowered when the dispersant is removed or reduced. In addition, the number of steps for preparing the pigment-encapsulating polymer dispersion is increased, and moreover there is need of periodically replacing an ultrafilter membrane that is a consumable member. There is thus a demand for developing an ad-miniemulsion polymerization process by which the dispersant is hard to be isolated.

In the conventional process in which the pigment and the dispersant are mixed and dispersed in water, and the monomer emulsion is caused to be adsorbed thereon to conduct polymerization, a dispersant which is not adsorbed on the pigment is liable to be isolated in the resulting pigment-encapsulating polymer dispersion. The reason for this is as follows. Since the dispersant only adsorbs on the surface of the pigment, the dispersant easily desorbs into water. Therefore, an equilibrium state in which the dispersant exists both in water and on the surface of the pigment is created. In addition, when the dispersant adsorbs on the surface of the pigment to cover the surface of the pigment with the dispersant, the monomer in the monomer emulsion may be hard to approach the surface of the pigment in some cases. Since the dispersant remains adsorbing on the surface of a pigment particle on which no monomer is adsorbed, the dispersant is isolated from the surface of the pigment by thermal motion when heated for polymerization. The reason why the dispersant is liable to be isolated in the resulting pigment-encapsulating polymer dispersion when the pigment and the dispersant are mixed and dispersed in water is thus considered to be as described above.

In addition, when the components are dispersed and polymerized after they are mixed without sufficiently dispersing the respective components as described in Patent Literature 1, the dispersant adsorbs on a monomer layer on the surface of the pigment. However, all the dispersant dissolved in water does not adsorb on the monomer layer, and a part thereof remains in water. Therefore, the dispersant is isolated in the resulting pigment-encapsulating polymer dispersion to cause problems of lowering of ejection characteristics, such as occurrence of a dot misalignment phenomenon.

### SUMMARY OF THE INVENTION

Accordingly, it is an object of the present invention to provide a process for producing a pigment-encapsulating polymer dispersion by which an ink jet ink excellent in ejection characteristics can be prepared. Another object of the present invention is to provide an ink jot ink using the pigment-encapsulating polymer dispersion produced by the above-described production process.

The above objects can be achieved by the present invention described below. That is, according to the present invention, there is provided a process for producing a pigment-encapsulating polymer dispersion, comprising the steps of dispersing a liquid containing a monomer, a hydrophobe and a polymerization initiator into a water medium with a dispersant to obtain a monomer emulsion, and mixing the monomer emulsion with a pigment dispersion containing a self-dispersible pigment to which a hydrophilic group is bonded directly or through another atomic group, and which is dispersed by the hydrophilic group, subjecting the resultant mixture to a shearing treatment and then polymerizing the monomer.

According to the present invention, there can be provided a process for producing a pigment-encapsulating polymer dispersion by which an ink jet ink excellent in ejection characteristics can be prepared, and an ink jet ink containing the pigment-encapsulating polymer dispersion produced by this production process.

Further features of the present invention will become apparent from the following description of exemplary embodiments.

### DESCRIPTION OF THE EMBODIMENTS

Preferred embodiments of the present invention will now be described in detail. The present inventors have carried out an extensive investigation in view of the above-described related art. As a result, a process for producing a pigment-encapsulating polymer dispersion, said process having the following constitution, has been found. That is, the process for producing the pigment-encapsulating polymer dispersion according to the present invention has the following steps (i) and (ii). The step (i) is a step of dispersing a liquid containing a monomer, a hydrophobe and a polymerization initiator into a water medium with a dispersant to obtain a monomer emulsion. The step (ii) is a step of mixing the monomer emulsion with a pigment dispersion containing a self-dispersible pigment (hereinafter also referred to as “self-dispersible pigment dispersion-”) , subjecting the resultant mixture to a shearing treatment and then polymerizing the monomer.

In the present invention, the monomer emulsion is prepared by using the dispersant in the step (i). In the step (ii), the self-dispersible pigment dispersion is prepared. After the monomer emulsion prepared is mixed with the self-dispersible pigment dispersion, the shearing treatment in which shearing force is applied is conducted. The shearing treatment is conducted, whereby fission, and fusion are repeatedly caused between the pigment and the monomer, and finally a thin monomer layer is stably adsorbed on the surface of the pigment. Thereafter, the monomer is polymerized under general polymerization conditions, whereby a pigment-encapsulating polymer dispersion can be obtained. A feature of such an ad-miniemulsion polymerization process resides in that the self-dispersible pigment and the monomer are respectively dispersed in advance, the shearing force is applied, and the polymerization is then conducted.

Step (i):

In the step (i), the liquid containing the monomer, she hydrophobe and the polymerization initiator is dispersed in the water medium with the dispersant to obtain the monomer emulsion. More specifically, the liquid containing the monomer, the hydrophobe and the polymerization initiator and the dispersant are stirred in water, and strong shearing force is applied, whereby the monomer emulsion can be prepared. Incidentally, as examples of a method for applying the strong shearing force, an ultrasonic treatment and a homogenizer treatment may be mentioned.

Monomer

No particular limitation is imposed on the monomer so far as it has polymerizability. However, the monomer is favorably a hydrophobic monomer. Specific examples of the monomer include styrene; and (meth)acrylate monomers such as methyl (meth)acrylate, ethyl (meth)acrylate, n-propyl (meth)acrylate, i-propyl (meth)acrylate, i-butyl (meth)acrylate, n-butyl (meth)acrylate, 2-ethylhexyl (meth)acrylate, 2-hydroxyethyl (meth)acrylate and benzyl (meth)acrylate. In addition, acrylamide, acrylonitrile, vinyl ether, vinyl acetate, vinylimidazole, ethylene, maleic acid derivatives and methyl (meth)acrylic acid may be mentioned.

Characteristics or properties required of the monomer and polymer include polymerization rate, polymerization conversion rate, glass transition temperature and affinity for a pigment. Thus, in order to achieve these characteristics or properties, two or more monomers may also be used.

Hydrophobe

The hydrophobe is used for stabilizing the monomer emulsion before polymerization. In the general ad-miniemulsion polymerization process, it is known to cause the following phenomenon. The phenomenon is a phenomenon called Ostwald ripening in which a monomer changes from a monomer emulsion fine particle having a large specific surface area and a small particle diameter to a monomer emulsion fine particle having a small specific surface area and a large particle diameter to be absorbed. Therefore, one unevenness of the particle diameter of a pigment-encapsulating polymer obtained by the polymerization becomes a problem. In order to inhibit the particle diameter of the pigment-encapsulating polymer from becoming uneven as described above, the hydrophobe which has affinity for the monomer and is hydrophobic is used. The change of the monomer can be thereby prevented to evenly retain the particle diameter of the monomer emulsion fine particle at the initial stage of emulsification. The content of the hydrophobe in the monomer emulsion is favorably 0.05% by mass or more and 0.20% by mass or less, more favorably 0.07% by mass or more and 0.15% by mass or less based on the total mass of the monomer.

Specific examples of the hydrophobe include hexadecane, hexadecanol, dodecyl methacrylate, stearyl methacrylate, octadecyl methacrylate, chlorobenzene, dodecylmercaptan, olive oil, blue dye (Blue 70) and polymethyl methacrylate.

Polymerization Initiator

As the polymerization initiator, either an oil-soluble polymerization initiator or a water-soluble polymerization initiator may be used. Specific examples of the oil-soluble polymerization initiator include azo polymerization initiators such as 2,2′-azobis(2-isobutyronitrile), 2,2′-azobis(2-methylbutyronitrile), 2,2′-asobis(2,4-dimethylvaleronitrile), 2,2′-azobis(4-methoxy-2,4-dimethylvaleronitrile), dimethyl-2,2′-azobis(2-methyl propionate), 1,1′-azobis(cyclohexane-1-carbonitrile), 2,2′azobis[N-(2-propenyl)-2-methyl-propionamide], 2,2′-azobis(N-butyl-2-methylpropionamide) and 2,2′-azobis(N-cyclohexyl-2-methylpropionamide). Specific examples of the water-soluble polymerization initiator include azo polymerization initiators such as 2,2′-azobis[N-(2-carboxyethyl)-2-methyl-propionamidine]hydrate, 2,2′-azobis{2-methyl-N-[1,1-bis(hydroxymethyl)-2-hydroxyethyl]propionamide} and 2,2′-azobis[2-methyl-N-(2-hydroxyethyl)propionamide]. The content of the polymerization initiator in the monomer emulsion is favorably 0.01% by mass or more and 0.1% by mass or less, more favorably 0.02% by mass or more and 0.07% by mass or less based on the total mass of the monomer.

Dispersant

The dispersant is an important component for dispersing the liquid containing the monomer, the hydrophobe and the initiator in a water medium. The dispersant includes, for example, a polymer dispersant, an anionic surfactant, a cationic surfactant or a nonionic surfactant. The content of the dispersant in the monomer emulsion is favorably 0.01% by mass or more and 0.30% by mass or less based on the total mass of the monomer.

As the polymer dispersant, a copolymer composed of a hydrophilic monomer and a hydrophobic monomer or a polymer composed of a monomer having a hydrophilic group and a hydrophobic group is favorably used. Specific examples of the hydrophobic monomer include styrene, styrene derivatives, vinylnaphthalene, vinylnaphthalene derivatives and aliphatic alcohol esters of α,β-ethylenically unsaturated carboxylic acids. Specific examples of the hydrophilic monomer include acrylic acid, acrylic acid derivatives, maleic acid, maleic acid derivatives, itaconic acid, itaconic acid derivatives, fumaric acid, fumaric acid derivatives, vinyl acetate, vinylpyrrolidone and acrylamide. As examples of copolymers composed of these monomers, random copolymers, block copolymers and graft copolymers may be mentioned.

The anionic surfactant is roughly divided into, for example, sulfate type, phosphate type, carboxylic acid type and sulfonic acid type. Specific examples of the sulfate type anionic surfactant include polyoxyethylene styryl phenyl ether sulfate salts (trade names: HITENOL NF-08, NF-0825, NF-13 and NF-17, products of DAI-ICHI KOGYO SEIYAKU CO., LTD.), polyoxyalkylene decyl ether sulfate salts (trade names: HITENOL XJ-16 and XJ-630S, products of DAI-ICHI KOGYO SEIYAKU CO., LTD.), polyoxyalkylene isodecyl ether sulfate salts (trade names; HITENOL PS-06 and PS-15, products of DAI-ICHI KOGYO SEIYAKU CO., LTD.), polyoxyalkylene tridecyl ether sulfate salts (trade names: HITENOL 330T and TM-07, products of DAI-ICHI KOGYO SEIYAKU CO., LTD.), polyoxyethylene lauryl ether sulfate salts (trade names: HITENOL 227L, 325L, LA-10, LA-12 and LA-16, products of DAI-ICHI KOGYO SEIYAKU CO,, LTD.), polyoxyethylene ether sulfate salts (trade name: HITENOL 325SM, product of DAI-ICHI KOGYO SEIYAKU CO., LTD.), and polyoxyethylene oleyl cetyl ether sulfate salts (trade names: HITENOL 08E, 16E and W-2320, products of DAI-ICHI KOGYO SEIYAKU CO., LTD.).

Specific examples of the phosphate type anionic surfactant include polyoxyethylene tridecyl ether phosphates (trade names: PLYSURF A212C and A215C, products of DAI-ICHI KOGYO SEIYAKU CO., LTD.), polyoxyethylene styryl phenyl ether phosphates (trade names: PLYSURF AL and AL12-H, products of DAI-ICHI KOGYO SEIYAKU CO., LTD.), polyoxyalkylene decyl ether phosphates (trade names: PLYSURF A208F and A208N, products of DAI-ICHI KOGYO SETYAKU CO., LTD.), polyoxyalkylene decyl ether phosphate salts (trade name: PLYSURF M208F, produce of DAI-ICHI KOGYO SEIYAKU CO., LTD.), polyoxyethylene lauryl ether phosphates (trade names: PLYSURF A208B, A210B and A219E, products of DAI-ICHI KOGYO SEIYAKU CO., LTD.), polyoxyethylene lauryl ether phosphate salts (trade name: PLYSURF DB-01, product of DAI-ICHI KOGYO SEIYAKU CO., LTD.), polyoxyethylene alkyl ether phosphates (trade name: PLYSURF A210D, product of DAI-ICHI KOGYO SEIYAKU CO., LTD.), and alkyl phosphate salts (trade names: PLYSURF DBS and DOM, products of DAI-ICHI KOGYO SEIYAKU CO., LTD.).

Specific examples of the carboxylic acid type anionic surfactant include polyoxyethylene lauryl ether acetate salts (trade names: NEO-HITENOL ECL-30S and ECL-45, products of DAI-ICHI KOGYO SEIYAKU CO., LTD.), lauryl sulfosuccinate salts (trade names: NEO-HITENOL LS, product of DAI-ICHI KOGYO SEIYAKU CO., LTD.), polyoxyethylene lauryl sulfosuccinate salts (trade name: NEO-HITENOL L-30S, product of DAI-ICHI KOGYO SEIYAKU CO., LTD.), polyoxyethylene alkyl sulfosuccinate salts (trade name: NEO-HITENOL S-70, product of DAI-ICHI KOGYO SEIYAKU CO., LTD.), higher fatty acid salts (trade name: KARI SEKKEN HY, product of DAI-ICHI KOGYO SEIYAKU CO., LTD.), and naphthenic acid salts.

Specific examples of the sulfonic acid type anionic surfactant include linear alkylbenzenesulfonic acid salts (trade names: NEOGEN S-20F and SC-F, products of DAI-ICHI KOGYO SEIYAKU CO., LTD.), alkylbenzenesulfonic acids (trade name: SAS-12F, product of DAI-ICHI KOGYO SEIYAKU CO., LTD.), α-olefin sulfonic acid salts (trade name: NEOGEN AO-90, product of DAI-ICHI KOGYO SEIYAKU CO., LTD.), phenolsulfonic acid (trade name: NEOGEN PSA-C, product of DAI-ICHI KOGYO SEIYAKU CO., LTD.), dioctylsulfosuccinic acid salts (trade names: NEOCOL SW, SW-C, P and YSK, products of DAI-ICHI KOGYO SEIYAKU CO., LTD.), lauryl sulfate salts (trade names: MONOGEN Y-100 and Y-500T, products of DAI-ICHI KOGYO SEIYAKU CO., LTD.), alkyl naphthalenesulfonate salts, and naphthalenesulfonic acid salts. Besides the above, formalin polycondensates, condensates of a higher fatty acid and an amino acid, acylated peptide and N-acylmethyltaurine may be used.

The cationic surfactant is roughly divided into quaternary ammonium salt type and amidoamine type. Specific example of the quaternary ammonium salt type cationic surfactant include alkyltrimethylammonium chlorides (trade names: CATIOGEN TML, TMP and TMS, products of DAI-ICHI KOGYO SEIYAKU CO., LTD.), alkyldimethylammonium ethyl sulfates (trade names: CATIOGEN ES-O; ES-OW, ES-L, ES-L-9 and ES-P, products of DAI-ICHI KOGYO SEIYAKU CO., LTD.), and alkyldimethylammonium chlorides (trade names: CATIOGEN DDM-PG, S and BS 50, products of DAI-ICHI KOGYO SEIYAKU CO., LTD.). As specific example of the amidoamine type cationic surfactant, alkyldimethylaminopropylamides may be mentioned.

The nonionic surfactant is roughly divided into ether type, ether ester type and ester type. Specific examples of the nonionic surfactant include polyoxyethylene sorbitan monopalmitate (trade name: NIKKOL TP-10V, product of NIKKO CHEMICALS CO., LTD.), polyoxyphytosterol (trade name: NIKKOL BPS-20, product of NIKKO CHEMICALS CO., LTD.), polyoxyethylene lanolins alcohol (trade name: NIKKOL BWA-10, product of NIKKO CHEMICALS CO., LTD.), decaglyceryl monolaurate (trade name: NIKKOL Decagin 1-L, product of NIKKO CHEMICALS CO., LTD.), polyoxyethylene sorbit monolaurate (trade name: NIKKOL GL-1, product of NIKKO CHEMICALS CO., LTD.), decaglyceryl monostearate (trade name: NIKKOL Decagln 1-50SV, product of NIKKO CHEMICALS CO., LTD.), polyoxyethylene hardened castor oil (trade name: NIKKOL HCO-80, product of NIKKO CHEMICALS CO., LTD.), polyethylene glycol monostearate (trade name; NIKKOL MYE-25, product of NIKKO CHEMICALS CO., LTD.), polyoxyethylene sorbitan monoisostearate (trade name: NIKKOL TI-10V, product of NIKKO CHEMICALS CO., LTD.), polyoxyethylene sorbitan monoolcate (trade names: NIKKOL TO-10V, 10MV, products of NIKKO CHEMICALS CO., LTD.), polyoxyethylene lanoline (trade name: NIKKOL TW-30, product of NIKKO CHEMICALS CO., LTD.), polyoxyethylene sorbitan monococoate (trade name: NIKKOL TL-10, product of NIKKO CHEMICALS CO., LTD.), polyoxyethylene behenyl ether (trade name: NIKKOL BB-20, product of NIKKO CHEMICALS CO., LTD.), polyethylene glycol distearate (trade name: NIKKOL CDS-6000F, product of NIKKO CHEMICALS CO., LTD.), polyoxyethylene hardened castor oil (trade name: NIKKOL KCO-100, product of NIKKO CHEMICALS CO., LTD.), polyoxyethylene polyoxypropylene cetyl ether (trade name: NIKKOL PBC-34, produce of NIKKO CHEMICALS CO., LTD.), polyoxyethylene oleyl ether (trade name: NIKKOL BO-15V, product of NIKKO CHEMICALS CO., LTD.), polyoxyethylene lanoline alcohol (trade name: NIKKOL BWA-20, product of NIKKO CHEMICALS CO., LTD.), polyethylene glycol monostearate (trade names: NIKKOL MYS-40MW and MYS-40V, products of NIKKO CHEMICALS CO., LTD,), polyoxyethylene cetyl ether (trade names: NIKKOL EC-20, 20V, produces of NIKKO CHEMICALS CO., LTD.), polyoxyethylene oleyl ether (trade name: NIKKOL BO-20V, product of NIKKO CHEMICALS CO., LTD.), polyoxyethylene lanoline alcohol (trade name: NIKKOL BWA-40, product of NIKKO CHEMICALS CO., LTD.), polyoxyethylene cholestanol (trade name: NIKKOL DHC-30, product of NIKKO CHEMICALS CO., LTD.), sodium polyoxyethylene lauryl ether phosphate (trade name: NIKKOL DLP-10, product of NIKKO CHEMICALS CO., LTD.), polyoxyethylene cetyl ether (trade names: EC-23, 25, products of NIKKO CHEMICALS CO., LTD.), polyoxyethylene behenyl ether (trade name: NIKKOL BB-30, product of NIKKO CHEMICALS CO., LTD.), polyoxyethylene oleyl ether (trade name: NIKKOL BO-50V, product of NIKKO CHEMICALS CO., LTD.), polyoxyethylene phytosterol (trade name: NIKKOL BPS-30, product of NIKKO CHEMICALS CO., LTD.), polyoxyethylene stearyl ether (trade name: NIKKOL BS-20, product of NIKKO CHEMICALS CO., LTD.), polyethylene glycol monostearate (trade names: MYS-45MV, 45V, 55MV, 55V, products of NIKKO CHEMICALS CO., LTD.), polyoxyethylene cetyl ether (trade name: BC-30, product of NIKKO CHEMICALS CO., LTD.), polyoxyethylene lauryl ether (trade names: BL-21, 25, products of NIKKO CHEMICALS CO., LTD.), and cetyl ether (trade name: BC-40, product of NIKKO CHEMICALS CO., LTD.). Incidentally, two or more dispersants may be used in combination.

Among these dispersants, polymer dispersants such as a styrene-acrylic polymer (styrene-acrylic acid copolymer) are liable to stick to surroundings of an ejection orifice when existing in an ink in an isolated state. Therefore, when the styrene-acrylic polymer is used as the dispersant, the effect of the present invention can be more markedly exhibited.

Step (ii):

In the step (ii), the self-dispersible pigment dispersion and the monomer emulsion are mixed and subjected to a shearing treatment to repeatedly cause fission and fusion between the pigment and the monomer, whereby a thin monomer layer is finally stably adsorbed on the surface of the pigment. The shearing treatment, is conducted by applying shearing force to the mixture of the self-dispersible pigment dispersion and the monomer emulsion. A method for applying the shearing force is favorably an ultrasonic treatment or a homogenizer treatment.

In the present invention, the formation of a particle with the monomer layer adsorbed on the self-dispersible pigment can be confirmed by the following method. After the shearing force is applied, density-gradient centrifugation is conducted. A supernatant liquid is collected and subjected to gas chromatography to confirm the lowering of the content of the monomer. When all the monomer is adsorbed on the pigment, the monomer is precipitated together with the pigment, so that no monomer is detected in the supernatant liquid.

After the self-dispersible pigment and the monomer emulsion are put together, the monomer is polymerized, whereby the pigment-encapsulating polymer dispersion can be obtained. As polymerization conditions, general conditions for emulsion polymerization may be applied. The temperature upon the polymerization may be not higher than a temperature at which water is refluxed. Specifically, the polymerization temperature is favorably 40° C. or more, more favorably 60° C. or more.

Self-Dispersible Pigment

In the present invention, the self-dispersible pigment means a pigment to which a hydrophilic group is bonded directly or through another atomic group and which is dispersed by the hydrophilic group. The pigment dispersion containing the self-dispersible pigment may further contain a dispersant. However, the content of the dispersant is favorably 0.40% by mass or less, more favorably 0.20% by mass or less, particularly favorably 0% by mass based on the total mass of the ink. That is, the pigment dispersion does particularly favorably not contain the dispersant.

Examples of a pigment used in the self-dispersible pigment include carbon black and color pigments. Among others, oxidized carbon black is favorable. Specific examples of carbon black include gas black, furnace black, medium thermal carbon black, acetylene black and Ketjen black. The gas black includes Color Black FW series and Special Black series. The furnace black includes HIBLACK series and Printex (both, products of Evonik Degussa Japan Co., Ltd.).

Specific examples of the color pigments include pigments such as a so pigments (including azo lake, insoluble azo pigments, fused azo pigments and chelate azo pigments), polycyclic pigments (for example, phthalocyanine pigments, perylene pigments, perynone pigments, thioindigo pigments, isoindolinone pigments and quinophthalone pigment), nitro pigments, and nitroso pigments.

Examples of the hydrophilic group being bonded to the surface of the pigment and imparting a self-dispersible function to the pigment include oxygen-containing hydrophilic groups such as carboxyl, ketone, hydroxyl, ester lactone and alkylene oxide groups; sulfur-containing hydrophilic groups such as sulfonic and sulfonic groups; a phosphoric group; and an amino group. Among these, hydrophilic groups such as a carboxyl group, a sulfonic group, a phosphoric group and an amino group are favorable because they are easily ionized in water by adjusting a pH to a proper value to generate an electric charge on the surface of the pigment, whereby electrostatic repulsion is caused, between pigment particles to make a dispersed state good.

As a specific method for introducing the hydrophilic group into the surface of the pigment, a method of treating a pigment with a hypohalogenous acid salt, ozone, nitric acid, nitrogen dioxide, sulfur dioxide or sulfur trioxide may be mentioned. A particular hydrophilic group may also be selectively bonded to the surface of the pigment by a diazo coupling method.

It is important that a hydrophobic surface of a monomer particle in the monomer emulsion comes into contact with a hydrophobic surface of the self-dispersible pigment upon the adsorption of the monomer particle on the self-dispersible pigment. The present inventors infer that when water surrounding the self-dispersible pigment exerts an influence at that time, such a phenomenon as described below occurs. When a hydrophilic group density on the surface of the pigment is low, water present in the vicinity of the surface of the pigment takes such an arrangement that interfacial energy between water and the pigment becomes the lowest. Therefore, water molecules surrounding a pigment particle cause hydrogen bonding to each other and are arranged like a basket covering the pigment particle. Therefore, the water molecule is prevented, from freely moving and restrained. Accordingly, the water restrained around the pigment particle is an obstacle to the adsorption of the monomer particle oil the hydrophobic surface of the pigment, and so the monomer particle becomes hard to be adsorbed. Thus, it is considered that, when a proper amount of a hydrophilic group is bonded to the surface of the pigment, an interaction occurs between the water surrounding the pigment particle and the hydrophilic group, whereby the basket of the water molecules is destroyed. The basket of the water molecules is destroyed, whereby the water molecule becomes easy to freely move. When the monomer particle approaches the pigment particle, the water molecule easily moves to make it easy for the monomer particle to be adsorbed.

Incidentally, if the hydrophilic group density on the surface of the pigment is too high, the hydrophilic group interacts with water though the formation of the basket of the water molecules which lowers the interfacial energy between the surface of the pigment and water is prevented, so that the pigment particle is hydrated so as to take an energetically most stable arrangement. Therefore, the water molecule is restrained so as to cover the pigment particle through the hydrophilic group. Accordingly, the water restrained around the pigment particle is an obstacle, and so the monomer particle may become hard to be adsorbed on the hydrophobic surface of the pigment in some cases. From the above-described reasons, a proper amount of the hydrophilic group is favorably bonded to the surface of the pigment for preventing water from being restrained around the pigment particle. In addition, a proper amount of the hydrophilic group is favorably bonded to the surface of the pigment even from the viewpoint of well dispersing the pigment without using the dispersant.

A hydrophilic group bonding amount to the surface of the self-dispersible pigment is favorably 50 μmol/g or more and 2,200 μmol/g or less, more favorably 100 μmol/g or more and 2,000 μmol/g or less in the case of a carboxyl group. Incidentally, the hydrophilic group (carboxyl group) bonding amount can be measured by a back titration method. Specifically, an acid is first added to a self-dispersible pigment dispersion to convert an ionized carboxyl group (COO⁻) into an unionized state (COOH). Centrifugation is then conducted to collect the self-dispersible pigment as a precipitate followed by drying. After an aqueous sodium hydrogencarbonate solution is added to a certain amount of the dried self-dispersible pigment, and the resultant mixture is stirred, the self-dispersible pigment is removed as a precipitate by centrifugation to obtain a supernatant liquid. The amount of sodium hydrogencarbonate remaining in the resultant supernatant liquid is titrated with an acid, whereby the hydrophilic group (carboxyl group) bonding amount to the surface of the pigment can be calculated.

Ink Jet Ink:

The ink jet ink according to the present invention is characterized by containing the pigment-encapsulating polymer dispersion produced by the above-described process for producing the pigment-encapsulating polymer dispersion according to the present invention. Thus, the ink jet ink according to the present invention is hard to cause a dot misalignment phenomenon and excellent in ejection characteristics. Incidentally, no particular limitation is imposed on other components than the pigment-encapsulating polymer dispersion contained in the ink jet ink according to the present invention so far as they are components capable of being contained in an ordinary ink jet ink.

The present invention will hereinafter be described more specifically by Examples and Comparative Examples. However, the present invention is not limited by the following Examples unless going beyond the gist of the present invention. Incidentally, “parts” or “part” and “%” in the sentences are based on the mass unless expressly noted.

Preparation of Pigment Dispersion:

Pigment Dispersion A

A 1-L flask was charged with 82 g of ion-exchanged water and 25 g of carbon black (trade name “Monarch 880”, product of Cabot), and the contents were stirred. After 322 g of an aqueous sodium hypochlorite solution having an effective chlorine concentration of 12% was further added, and stirring was conducted, a Dimroth condenser was installed in the flask, and stirring was conducted for 8 hours while heating to 105° C. by using an oil bath. After solids obtained, by centrifuging a reaction liquid taken out were redispersed in water, centrifugation was conducted again to obtain a cake. After the resultant cake was redispersed in water, ultrafiltration was conducted. Thereafter, the resultant filtrate was concentrated to obtain Pigment Dispersion A of a self-dispersion type in which the carbon black content was 8.2%. The amount of a carboxyl group bonded to the carbon black contained in the resultant Pigment Dispersion A was 872 μmol/g. The particle diameter (d50) of the carbon black was 85 nm, and the dispersed state thereof was good.

Pigment Dispersion B

A 1-L flask was charged with 354 g of ion-exchanged water and 25 g of carbon black (trade name “Monarch 880”; product of Cabot), and the contents were stirred. Fifty grams of an aqueous sodium hypochlorite solution having an effective chlorine concentration of 12% was further added, and stirring was conducted. Thereafter, the resultant mixture was processed in the same manner as in “Pigment Dispersion A” to obtain Pigment Dispersion B of a self-dispersion type in which the carbon black content was 8.2%. The amount of a carboxyl group bonded to the carbon black contained in the resultant Figment Dispersion B was 250 μmol/g. The particle diameter (d50) of the carbon black was 96 nm, and the dispersed state thereof was good.

Pigment Dispersion C

A 1-L flask was charged with 82 g of ion-exchanged water and 25 g of carbon black (trade name “Monarch 880”, product of Cabot), and the contents were stirred. After 322 g of an aqueous sodium hypochlorite solution having an effective chlorine concentration of 12% was further added, and stirring was conducted, a Dimroth condenser was installed in the flask, and stirring was conducted for 8 hours while heating to 105° C. by using an oil bath. A reaction liquid taken out was centrifuged to obtain a cake. After 82 g of ion-exchanged, water was added to the resultant cake, and stirring was conducted, 322 g of an aqueous sodium hypochlorite solution having an effective chlorine concentration of 12% was added, and stirring was conducted. A Dimroth condenser was installed in the flask, and stirring was conducted for 8 hours while heating to 105° C. by using an oil bath. After solids obtained by centrifuging a reaction liquid taken out were redispersed in water, centrifugation was conducted, again to obtain a cake. Thereafter, the cake was processed in the same manner as in “Pigment Dispersion A” to obtain Pigment Dispersion C of a self-dispersion type in which the carbon black content was 8.2%. The amount of a carboxyl group bonded to the carbon black contained in the resultant Pigment Dispersion C was 1,100 μmol/g. The particle diameter (d50) of the carbon black was 83 nm, and the dispersed state thereof was good.

Pigment Dispersion D

A 1-L flask was charged with 354 g of ion-exchanged water and 25 g of carbon black (trade name “Monarch 880”, product of Cabot), and the contents were stirred. Twenty grams of an aqueous sodium hypochlorite solution having an effective chlorine concentration of 12% was further added, and stirring was conducted. Thereafter, the resultant mixture was processed in the same manner as in “Pigment Dispersion A” to obtain Pigment Dispersion D of a self-dispersion type in which the carbon black content was 8.2%. The amount of a carboxyl group bonded to the carbon black contained in the resultant Pigment Dispersion D was 105 μmol/g. The particle diameter (d50) of the carbon black was 94 nm, and the dispersed state thereof was good.

Pigment Dispersion E

A 1-L flask was charged with 82 g of ion-exchanged water and 25 g of carbon black (trade name “Monarch 880”, product of Cabot), and the contents were stirred. After 322 g of an aqueous sodium hypochlorite solution having an effective chlorine concentration of 12% was further added, and stirring was conducted, a Dimroth condenser was installed in the flask, and stirring was conducted for 8 hours while heating to 105° C. by using an oil bath. A reaction liquid taken out was centrifuged to obtain a cake. After 82 g of ion-exchanged water was added to the resultant cake, and stirring was conducted, 322 g of an aqueous sodium hypochlorite solution having an effective chlorine concentration of 12% was added, and stirring was conducted. A Dimroth condenser was installed in the flask, and stirring was conducted for 8 hours while heating to 105° C. by using an oil bath. A reaction liquid taken out was centrifuged again to obtain a cake. After 82 g of ion-exchanged water was added to the resultant cake, and stirring was conducted, 322 g of an aqueous sodium hypochlorite solution having an effective chlorine concentration of 12% was added, and stirring was conducted. A Dimroth condenser was installed in the flask, and stirring was conducted for 8 hours while heating to 105° C. by using an oil bath. After solids obtained by centrifuging a reaction liquid taken out were redispersed in water, centrifugation was conducted again to obtain a cake. Thereafter, the cake was processed in the same manner as in “Pigment Dispersion A” to obtain Pigment Dispersion E of a self-dispersion type in which, the carbon black content was 8.2%. The amount of a carboxyl group bonded to the carbon black contained in the resultant Pigment Dispersion E was 1,805 μmol/g. The particle diameter (d50) of the carbon black was 82 nm, and the dispersed state thereof was good.

Pigment Dispersion F

A 1-L flask was charged with 82 g of ion-exchanged water and 25 g of carbon black (trade name “Monarch 880”, product of Cabot), and the contents were stirred. After 322 g of an aqueous sodium hypochlorite solution having an effective chlorine concentration of 12% was further added, and stirring was conducted, a Dimroth condenser was installed in the flask, and stirring was conducted for 8 hours while heating to 105° C. by using an oil bath. A reaction liquid taken out was centrifuged to obtain a cake. After 82 g of ion-exchanged water was added to the resultant cake, and stirring was conducted, 322 g of an aqueous sodium hypochlorite solution having an effective chlorine concentration of 12% was added, and stirring was conducted. A Dimroth condenser was installed in the flask, and stirring was conducted for 8 hours while heating to 105° C. by using an oil bath. A reaction liquid taken out was centrifuged again to obtain a cake. After 82 g of ion-exchanged water was added to the resultant cake, and stirring was conducted, 322 g of an aqueous sodium hypochlorite solution having an effective chlorine concentration of 12% was added, and stirring was conducted. A Dimroth condenser was installed in the flask, and stirring was conducted for 8 hours while heating to 105° C. by using an oil bath. A reaction liquid taken out was centrifuged further again to obtain a cake. After 82 g of ion-exchanged water was added to the resultant cake, and stirring was conducted, 322 g of an aqueous sodium hypochlorite solution having an effective chlorine concentration of 12% was added, and stirring was conducted. A Dimroth condenser was installed in the flask, and stirring was conducted for 8 hours while heating to 105° C. by using an oil bath. After solids obtained by centrifuging a reaction liquid taken out were redispersed in water, centrifugation was conducted again to obtain a cake. Thereafter, the cake was processed in the same manner as in “Pigment Dispersion A” to obtain Pigment Dispersion F of a self-dispersion type in which the carbon black content was 8.2%. The amount of a carboxyl group bonded to the carbon black contained in the resultant-Pigment Dispersion F was 2,120 μmol/g. The particle diameter (d50) of the carbon black was 85 nm, and the dispersed state thereof was good.

Pigment Dispersion G

A 1-L flask was charged with 354 g of ion-exchanged water and 25 g of carbon black (trade name “Monarch 880”, product of Cabot), and the contents were stirred. Ten grams of an aqueous sodium hypochlorite solution having an effective chlorine concentration of 12% was further added, and stirring was conducted. Thereafter, the resultant mixture was processed in the same manner as in “Pigment Dispersion A” to obtain Pigment Dispersion G of a self-dispersion type in which the carbon black content was 8.2%, The amount of a carboxyl group bonded to the carbon black contained in the resultant Pigment Dispersion G was 52 μmol/g. The particle diameter (d50) of the carbon black was 88 nm, and the dispersed state thereof was good.

Pigment Dispersion H

It was attempted to prepare a dispersion in which the carbon black content was 8.2% by using 10 g of untreated carbon black (trade name “Monarch 880”, product of Cabot), 1 g of sodium dodecyl sulfate and water and subjecting the resultant mixture to ultrasonication. However, coarse particles were present even by the ultrasonication, and the carbon black was not successfully dispersed. Thus, 2.5 g of sodium dodecyl sulfate was additionally added to conduct ultrasonication. As a result, the carbon black was able to be dispersed. In this manner, Pigment Dispersion H in which the carbon black content was 8.2% and the sodium dodecyl sulfate content was 2.5% was obtained. The particle diameter (d50) of the carbon black contained in the resultant Pigment Dispersion H was 85 nm, and the dispersed state thereof was good.

Pigment Dispersion I

Pigment Dispersion I in which the carbon black content was 8.2% and the sodium dodecyl sulfate content was 0.41% was obtained in the same manner as in “Pigment Dispersion A” except that sodium dodecyl sulfate was added before the concentration. The particle diameter (d50) of the carbon black contained in the resultant Pigment. Dispersion I was 32 nm, and the dispersed state thereof was good.

Preparation of Monomer Emulsion:

Monomer Emulsion a

Ten grams of styrene, 1 g of hexadecane and 0.5 g of 2,2′-azobis(2-methylbutyronitrile) were mixed in a 50-mL beaker, and these were dissolved to obtain a compatible product. The resultant compatible product was added into 70 g of a 3% aqueous solution of sodium dodecyl sulfate in a 200-mL beaker. Thereafter, ultrasonic waves were applied for 45 minutes by means of an ultrasonic disperser to obtain Monomer Emulsion a. The particle diameter (d50) of emulsion particles contained in the resultant Monomer Emulsion a was 110 nm, and the dispersed state thereof was good.

Monomer Emulsion b

Monomer emulsion b was obtained in the same manner as in “Monomer Emulsion a” except that polyoxyethylene cetyl ether (trade name “BC-40”, product of product of NIKKO CHEMICALS CO., LTD.) was used in place of the aqueous sodium dodecyl sulfate solution. The particle diameter (d50) of emulsion particles contained in the resultant Monomer Emulsion b was 145 nm, and the dispersed state thereof was good.

Monomer Emulsion c

Monomer Emulsion c was obtained in the same manner as in “Monomer Emulsion a” except that an aqueous solution of a styrene-acrylic polymer (styrene-acrylic acid copolymer, acid value: 150 mg KOH/g, weight-average molecular weight: 8,000) was used in place of the aqueous sodium dodecyl sulfate solution. The particle diameter (d50) of emulsion particles contained in the resultant Monomer Emulsion c was 155 nm. and the dispersed state thereof was good.

Monomer Emulsion d

Monomer Emulsion d was obtained in the same manner as in “Monomer Emulsion a” except that an aqueous sodium dodecyl sulfate solution having a concentration of 6% was used. The particle diameter (d50) of emulsion particles contained in the resultant Monomer Emulsion d was 105 nm, and the dispersed state thereof was good.

Production of Pigment-Encapsulating Polymer Dispersion:

### EXAMPLE 1

A uniform dispersion was obtained by mixing 12.8 g of Monomer Emulsion a and 80 g of Pigment Dispersion A and applying ultrasonic waves for 20 minutes. The resultant dispersion was held for 8 hours at 80° C. in an oil bath to conduct ad-miniemulsion polymerization. Thereafter, the resultant polymerization product was naturally cooled to obtain Pigment-Encapsulating Polymer Dispersion 1. The particle diameter (d50) of the pigment-encapsulating polymer contained in the resultant Pigment-Encapsulating Polymer Dispersion 1 was 88 nm, and the dispersed state thereof was good.

### EXAMPLE 2

Pigment-Encapsulating Polymer Dispersion 2 was obtained in the same manner as in Example 1 except that Monomer Emulsion b was used in place of Monomer Emulsion a. The particle diameter (d50) of the pigment-encapsulating polymer contained in the resultant Pigment-Encapsulating Polymer Dispersion 2 was 86 nm, and the dispersed state thereof was good.

### EXAMPLE 3

Pigment-Encapsulating Polymer Dispersion 3 was obtained in the same manner as in Example 1 except that Monomer Emulsion c was used in place of Monomer Emulsion a. The particle diameter (d50) of the pigment-encapsulating polymer contained in the resultant Pigment-Encapsulating Polymer Dispersion 3 was 85 nm, and the dispersed state thereof was good.

### EXAMPLE 4

Pigment-Encapsulating Polymer Dispersion 4 was obtained in the same manner as in Example 1 except that Monomer Emulsion d was used in place of Monomer Emulsion a. The particle diameter (d50) of the pigment-encapsulating polymer contained in the resultant Pigment-Encapsulating Polymer Dispersion 4 was 82 nm, and the dispersed state thereof was good.

### EXAMPLE 5

Pigment-Encapsulating Polymer Dispersion 5 was obtained in the same manner as in Example 1 except that Pigment Dispersion B was used in place of Pigment Dispersion A. The particle diameter (d50) of the pigment-encapsulating polymer contained in the resultant Pigment-Encapsulating Polymer Dispersion 5 was 99 nm, and the dispersed state thereof was good.

### EXAMPLE 6

Pigment-Encapsulating Polymer Dispersion 6 was obtained in the same manner as in Example 1 except that Figment Dispersion C was used in place of Pigment Dispersion A. The particle diameter (d50) of the pigment-encapsulating polymer contained in the resultant Pigment-Encapsulating Polymer Dispersion 6 was 81 nm, and the dispersed state thereof was good.

### EXAMPLE 7

Pigment-Encapsulating Polymer Dispersion 7 was obtained in the same manner as in Example 1 except that Pigment Dispersion D was used in place of Pigment Dispersion A. The particle diameter (d50) of the pigment-encapsulating polymer contained in the resultant Pigment-Encapsulating Polymer Dispersion 7 was 84 nm, and the dispersed state thereof was good.

### EXAMPLE 8

Pigment-Encapsulating Polymer Dispersion 8 was obtained in the same manner as in Example 1 except that Pigment Dispersion E was used in place of Pigment Dispersion A. The particle diameter (d50) of the pigment-encapsulating polymer contained in the resultant Pigment-Encapsulating Polymer Dispersion 8 was 86 nm, and the dispersed state thereof was good.

### EXAMPLE 9

Pigment-Encapsulating Polymer Dispersion 9 was obtained in the same manner as in Example 1 except that Pigment Dispersion F was used in place of Pigment Dispersion A. The particle diameter (d50) of the pigment-encapsulating polymer contained in the resultant Pigment-Encapsulating Polymer Dispersion 9 was 82 nm, and the dispersed state thereof was good.

### EXAMPLE 10

Pigment-Encapsulating Polymer Dispersion 10 was obtained in the same manner as in Example 1 except that Pigment Dispersion G was used in place of Pigment Dispersion A. The particle diameter (d50) of the pigment-encapsulating polymer contained in the resultant Pigment-Encapsulating Polymer Dispersion 10 was 85 nm; and the dispersed state thereof was good.

### EXAMPLE 11

Pigment-Encapsulating Polymer Dispersion 11 vas obtained in the same manner as in Example 1 except that Pigment Dispersion 1 was used in place of Pigment Dispersion A. The particle diameter (d50) of the pigment-encapsulating polymer contained in the resultant Pigment-Encapsulating Polymer Dispersion 11 was 83 nm, and the dispersed state thereof was good.

### Comparative Example 1

Pigment-Encapsulating Polymer Dispersion 12 was obtained in the same manner as in Example 1 except that Pigment Dispersion H was used in place of Pigment Dispersion A. The particle diameter (d50) of the pigment encapsulating polymer contained in the resultant Pigment-Encapsulating Polymer Dispersion 12 was 88 nm, and the dispersed state thereof was good.

### Comparative Example 2

The respective components were used so as to give the same component ratio as in Example 4. However, Pigment-Encapsulating Polymer Dispersion 13 was prepared by a different process. Specifically, after Pigment Dispersion A and sodium dodecyl sulfate were mixed, a mixed liquid of styrene, hexadecane and 2,2-asobis(2-methylbutyronitrile) was added, and ultrasonic waves were applied to obtain a uniform dispersion. The resultant dispersion was held for 8 hours at 80° C. in an oil bath to conduct polymerization. Thereafter, the resultant polymerization product was naturally cooled to obtain Pigment-Encapsulating Polymer Dispersion 13. The particle diameter (d50) of the pigment-encapsulating polymer contained in the resultant Pigment-Encapsulating Polymer Dispersion 13 was 83 nm, and the dispersed state thereof was good.

The compositions of the pigment dispersions and the compositions of the pigment-encapsulating polymer dispersions are shown in Table 1 and Tables 2-1 to 2-3, respectively.

TABLE 1
Compositions of pigment dispersions

| Pigment dispersion | | A | B | C | D | E | F | G | H | I |
|---|---|---|---|---|---|---|---|---|---|---|
| Carbon | Functional group | 8.2 | | | | | | | | 8.2 |
| black | bonding amount: | | | | | | | | | |
| | 872 μmol/g | | | | | | | | | |
| | Functional group | | 8.2 | | | | | | | |
| | bonding amount: | | | | | | | | | |
| | 250 μmol/g | | | | | | | | | |
| | Functional group | | | 8.2 | | | | | | |
| | bonding amount: | | | | | | | | | |
| | 1100 μmol/g | | | | | | | | | |
| | Functional group | | | | 8.2 | | | | | |
| | bonding amount: | | | | | | | | | |
| | 105 μmol/g | | | | | | | | | |
| | Functional group | | | | | 8.2 | | | | |
| | bonding amount: | | | | | | | | | |
| | 1805 μmol/g | | | | | | | | | |
| | Functional group | | | | | | 8.2 | | | |
| | bonding amount: | | | | | | | | | |
| | 2120 μmol/g | | | | | | | | | |
| | Functional group | | | | | | | 8.2 | | |
| | bonding amount: | | | | | | | | | |
| | 52 μmol/g | | | | | | | | | |
| | Functional group | | | | | | | | 8.2 | |
| | bonding amount: | | | | | | | | | |
| | 0 μmol/g | | | | | | | | | |

| | | | | | | | | | |
|---|---|---|---|---|---|---|---|---|---|
| Sodium dodecyl sulfate | 0 | 0 | 0 | 0 | 0 | 0 | 0 | 2.5 | 0.41 |
| water | Bal. | Bal. | Bal. | Bal. | Bal. | Bal. | Bal. | Bal. | Bal. |
| Carbon black:dispersant | 1:0 | 1:0 | 1:0 | 1:0 | 1:0 | 1:0 | 1:0 | 1:0.3 | 1:0.05 |
| (mass ratio) | | | | | | | | | |

TABLE 2-1
Compositions of pigment-encapsulating polymer dispersions

| | | Ex. 1 | Ex. 2 | Ex. 3 | Ex. 4 | Ex. 5 |
|---|---|---|---|---|---|---|
| Pigment-encapsulating polymer | | 1 | 2 | 3 | 4 | 5 |
| dispersion | | | | | | |
| Pigment dispersion | | A | A | A | A | B |
| Monomer emulsion | | a | b | c | d | a |
| Carbon black | Functional group bonding | 7.1 | 7.1 | 7.1 | 7.1 | |
| | amount: 872 μmol/g | | | | | |
| | Functional group bonding | | | | | 7.1 |
| | amount: 250 μmol/g | | | | | |
| | Functional group bonding | | | | | |
| | amount: 1100 μmol/g | | | | | |
| | Functional group bonding | | | | | |
| | amount: 105 μmol/g | | | | | |
| | Functional group bonding | | | | | |
| | amount: 1805 μmol/g | | | | | |
| | Functional group bonding | | | | | |
| | amount: 2120 μmol/g | | | | | |
| | Functional group bonding | | | | | |
| | amount: 52 μmol/g | | | | | |
| | Functional group bonding | | | | | |
| | amount: 0 μmol/g | | | | | |

| | | | | | |
|---|---|---|---|---|---|
| Styrene | 1.7 | 1.7 | 1.7 | 1.7 | 1.7 |
| Hexadecane | 0.17 | 0.17 | 0.17 | 0.17 | 0.17 |
| Polymerization initiator | 0.08 | 0.08 | 0.08 | 0.08 | 0.08 |
| Sodium dodecyl sulfate | 0.36 | | | 0.71 | 0.36 |
| Styrene-acrylic polymer | | 0.36 | | | |
| BC-30 | | | 0.36 | | |
| Water | Bal. | Bal. | Bal. | Bal. | Bal. |
| Carbon black:dispersant (mass ratio) | 1:0.05 | 1:0.05 | 1:0.05 | 1:0.1 | 1:0.05 |
| Carbon black:dispersant derived from | 1:0 | 1:0 | 1:0 | 1:0 | 1:0 |
| pigment dispersion (mass ratio) | | | | | |
| Carbon black:dispersant derived from | 1:0.05 | 1:0.05 | 1:0.05 | 1:0.1 | 1:0.05 |
| monomer emulsion (mass ratio) | | | | | |
| Dispersant not derived from monomer | Not | Not | Not | Not | Not |
| emulsion | used | used | used | used | used |

TABLE 2-2
Compositions of pigment-encapsulating polymer dispersions

| | | Ex. 6 | Ex. 7 | Ex. 8 | Ex. 9 |
|---|---|---|---|---|---|
| Pigment-encapsulating polymer | | 6 | 7 | 8 | 9 |
| dispersion | | | | | |
| Pigment dispersion | | C | D | E | F |
| Monomer emulsion | | a | a | a | a |
| Carbon | Functional group | | | | |
| black | bonding amount: | | | | |
| | 872 μmol/g | | | | |
| | Functional group | | | | |
| | bonding amount: | | | | |
| | 250 μmol/g | | | | |
| | Functional group | 7.1 | | | |
| | bonding amount: | | | | |
| | 1100 μmol/g | | | | |
| | Functional group | | 7.1 | | |
| | bonding amount: | | | | |
| | 105 μmol/g | | | | |
| | Functional group | | | 7.1 | |
| | bonding amount: | | | | |
| | 1805 μmol/g | | | | |
| | Functional group | | | | 7.1 |
| | bonding amount: | | | | |
| | 2120 μmol/g | | | | |
| | Functional group | | | | |
| | bonding amount: | | | | |
| | 52 μmol/g | | | | |
| | Functional group | | | | |
| | bonding amount: | | | | |
| | 0 μmol/g | | | | |

| | | | | |
|---|---|---|---|---|
| Styrene | 1.7 | 1.7 | 1.7 | 1.7 |
| Hexadecane | 0.17 | 0.17 | 0.17 | 0.17 |
| Polymerization initiator | 0.08 | 0.08 | 0.08 | 0.08 |
| Sodium dodecyl sulfate | 0.36 | 0.36 | 0.36 | 0.36 |
| Styrene-acrylic polymer | | | | |
| BC-30 | | | | |
| Water | Bal. | Bal. | Bal. | Bal. |
| Carbon black:dispersant | 1:0.05 | 1:0.05 | 1:0.05 | 1:0.05 |
| (mass ratio) | | | | |
| Carbon black:dispersant | 1:0 | 1:0 | 1:0 | 1:0 |
| derived from pigment | | | | |
| dispersion (mass ratio) | | | | |
| Carbon black:dispersant | 1:0.05 | 1:0.05 | 1:0.05 | 1:0.05 |
| derived from monomer | | | | |
| emulsion (mass ratio) | | | | |
| Dispersant not derived | Not | Not | Hot | Not |
| from monomer emulsion | used | used | used | used |

TABLE 2-1
Compositions of pigment-encapsulating polymer dispersions

| | | | | Comp. | Comp. |
|---|---|---|---|---|---|
| | | Ex. 10 | Ex. 11 | Ex. 1 | Ex. 2 |
| Pigment-encapsulating polymer | | 10 | 11 | 12 | 13 |
| dispersion | | | | | |
| Pigment dispersion | | G | I | H | A |
| Monomer emulsion | | a | a | a | — |
| Carbon | Functional group | | 7.1 | | 7.1 |
| black | bonding amount: | | | | |
| | 872 μmol/g | | | | |
| | Functional group | | | | |
| | bonding amount: | | | | |
| | 250 μmol/g | | | | |
| | Functional group | | | | |
| | bonding amount: | | | | |
| | 1100 μmol/g | | | | |
| | Functional group | | | | |
| | bonding amount: | | | | |
| | 105 μmol/g | | | | |
| | Functional group | | | | |
| | bonding amount: | | | | |
| | 1805 μmol/g | | | | |
| | Functional group | | | | |
| | bonding amount: | | | | |
| | 2120 μmol/g | | | | |
| | Functional group | 7.1 | | | |
| | bonding amount: | | | | |
| | 52 μmol/g | | | | |
| | Functional group | | | 7.1 | |
| | bonding amount: | | | | |
| | 0 μmol/g | | | | |

| | | | | |
|---|---|---|---|---|
| Styrene | 1.7 | 1.7 | 1.7 | 1.7 |
| Hexadecane | 0.17 | 0.17 | 0.17 | 0.17 |
| Polymerization initiator | 0.08 | 0.08 | 0.08 | 0.08 |
| Sodium dodecyl sulfate | 0.36 | 0.71 | 2.5 | 0.71 |
| Styrene-acrylic polymer | | | | |
| BC-30 | | | | |
| Water | Bal. | Bal. | Bal. | Bal. |
| Carbon black:dispersant | 1:0.05 | 1:0.1 | 1:0.35 | 1:0.1 |
| (mass ratio) | | | | |
| Carbon black:dispersant | 1:0 | 1:0.05 | 1:0.3 | 1:0 |
| derived from pigment | | | | |
| dispersion (mass ratio) | | | | |
| Carbon black:dispersant | 1:0.05 | 1:0.05 | 1:0.05 | 1:0 |
| derived from monomer | | | | |
| emulsion (mass ratio) | | | | |
| Dispersant not derived | Not used | Used | Used | Used |
| from monomer emulsion | | | | |

Preparation of Ink:

Each of the pigment-encapsulating polymer dispersions produced was used, respective components were mixed according to the following formulation (100 parts in total), and the resultant mixture was filtered through a filter having a pore size of 5 μm to obtain an ink.

Pigment-encapsulating polymer dispersion: 3 parts

Glycerol: 10 parts

Acetylenol E100 (product of Kawaken Fine Chemicals Co., Ltd.): 1 part

Water: Balance.

Evaluation of Ejection Performance:

The ink prepared was set in an ink jet printer (trade name “PIXUS Pro 9500”, manufactured by Canon Inc.) to print a black solid pattern on A4-sized paper sheets. A check pattern was printed after the solid pattern was printed on a fixed number of paper sheets to confirm whether ink droplets in the printed article were located at the predetermined positions or not, thereby evaluating the ejection performance of the ink according to the following criteria. Evaluation results are shown in Table 3.

A: No dot misalignment phenomenon occurs even after printed on 10 paper sheets;

B: Dot misalignment phenomenon occurs after printed on 10 paper sheets;
C: Dot misalignment phenomenon occurs after printed on 5 paper sheets;
D: Dot misalignment phenomenon occurs after printed on 3 paper sheets;

TABLE 3
Evaluation results

| | Ejection performance |
|---|---|
| Example 1 | A |
| Example 2 | A |
| Example 3 | A |
| Example 4 | B |
| Example 5 | A |
| Example 6 | A |
| Example 7 | A |
| Example 8 | A |
| Example 9 | B |
| Example 10 | B |
| Example 11 | B |
| Comparative | D |
| Example 1 | |
| Comparative | C |
| Example 2 | |

Incidentally, although the ejection performance of Example 11 was ranked as “B” , the performance was poorer-compared with Examples 4, 9 and 10 that were also ranked as “B”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-162988, filed Jul. 23, 2012, which is hereby incorporated by reference herein in its entirety.

What is claimed is:

1. A process for producing a pigment-encapsulating polymer dispersion, comprising the steps of:
dispersing a liquid containing a monomer, a hydrophobe and a polymerization initiator into a water medium with a dispersant to obtain a monomer emulsion; and
mixing the monomer emulsion with a pigment dispersion containing a self-dispersible pigment to which a hydrophilic group is bonded directly or through another atomic group and which is dispersed by the hydrophilic group, subjecting the resultant mixture to a shearing treatment and then polymerizing the monomer.

2. The process according to claim 1, wherein the dispersant is at least one selected from the group consisting of a polymer dispersant, an anionic surfactant, a cationic surfactant and a nonionic surfactant, and the content of the dispersant in the monomer emulsion is 0.01% by mass or more and 0.30% by mass or less based on the total mass of the monomer.

3. The process according to claim 1, wherein the pigment dispersion contains no dispersant.

4. The process according to claim 1, wherein the self-dispersible pigment is an oxidized carbon black.

5. The process according to claim 1, wherein the hydrophilic group is a carboxyl group, and a bonding amount of the carboxyl group to a surface of the self-dispersible pigment is 100 μmol/g or more and 2,000 μmol/g or less.

6. An ink jet ink comprising a pigment-encapsulating polymer dispersion produced by the process according to claim 1.
